(19) United States
(12) Patent Application Publication
(10) Pub. No.: US 2007/0265821 A1
(43) Pub. Date: Nov. 15, 2007

(54) Simulation apparatus, simulation method, and computer-readable recording medium storing simulation program

(76) Inventors: Ryo Yokoyama, Kanagawa (JP); Masahiko Saito, Kanagawa (JP); Kenji Ejima, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 11/798,244

(22) Filed: May 11, 2007

(30) Foreign Application Priority Data
May 12, 2006 (JP) 2006-133300

(51) Int. Cl. G06F 17/50

(52) U.S. Cl. 703/14

(57) ABSTRACT

The present invention aims to easily detect incorrect accesses caused by the simultaneous operation of a plurality of circuits and to reduce the time and developing costs required for analyses to specify the incorrect accesses. First and second access order storages prestore access order information representing correct access orders of data to be inputted to and outputted from first and second simulation circuits. First and second access monitors obtain information on the input and output of data to and from the first and second simulation circuits as access information, and judge whether or not an order of obtaining the access information is correct based on the access order information stored in the first and second access order storages. A warning notifier notifies a warning to the user if the order of obtaining the access information is judged to be incorrect.

### BACKGROUND OF THE INVENTION

1. Field of the Invention

The present invention relates to a simulation apparatus and a simulation method for simulating the operation of a system circuit including a plurality of circuits, and a computer-readable recording medium storing a simulation program and particularly to the development and verification of software utilizing a simulation apparatus, a simulation method and a computer-readable recording medium storing a simulation program.

2. Description of the Background Art

Digital audio visual products have been amazingly developed in recent years and steadily become more complicated. Particularly, there has been a remarkable increase in needs for audio processing and video processing. Reflecting such a situation, processors based on digital audio visual products have come to possess not only a conventionally known central processing unit (hereinafter, “CPU”) and a memory, but also a digital signal processor (hereinafter, “DSP”) and a special processing unit (hereinafter, “hard engine”) for performing a special processing such as an image processing.

The construction and operation of a conventional simulation apparatus as an existing technology relating to the present invention are described with reference to FIG. 17. FIG. 17 is a diagram showing the construction of the conventional simulation apparatus.

A simulation apparatus 101 is for simulating the operation of a system circuit and is typically implemented as a software program on a computer system. This simulation apparatus 101 includes a simulation target 102 as a component similar to the system circuit used in an actuator product. The simulation target 102 includes simulation circuits 103, 104, a simulation bus 105 and a simulation memory 106.

The simulation circuits 103, 104 simulate a processor (CPU, DSP, DMA (direct memory access) controller, hard engine and the like) provided in a system circuit. The simulation circuit 103 simulates, for example, the operation of the CPU, and the simulation circuit 104 simulates, for example, the operation of a peripheral circuit. It should be noted that the simulation circuit may have one or more simulation CPUs. There may be 0 or more other simulation circuits. The simulation bus 105 simulates a bus installed in the system circuit. The simulation memory 106 simulates the memory installed in the system circuit. The type of the memory differs depending on the system configuration such as a SDRAM or a flash memory. There may be one or more simulation memories 106.

Each simulation circuit simulates the operation of a circuit installed in the actual system circuit. Thus, software implemented on the system circuit used in the actual product is virtually implemented on the simulation apparatus. However, the operating speed of the simulation apparatus is generally slower than that of the actual system circuit. Further, there are cases where the accuracy of the simulation apparatus and the processing timings of the respective simulation circuits slightly differ from those of the actual system circuit depending on simulation range and accuracy.

Next, a hardware emulator is described as an existing technology. The hardware emulator is a simulation apparatus for simulating circuits utilizing a design program of the actual system circuit. Thus, the hardware emulator is the simulation apparatus having the simulation range and accuracy equivalent to those of the actual system circuit and completely simulating processings including those during glitches, and is often used for the verification of the circuits. However, the operating speed is fairly slower as compared to the actual system circuit.

Next, prior art disclosed in Japanese Unexamined Patent Publication No. 2005-128692 is summarily described. A simulation apparatus disclosed in this publication is provided with a function of checking an access to a resource that is not intended by a software developer.

The above simulation apparatus includes a memory element, a register element, a control element, command input means and resource access analyzing means. The memory element represents a memory storing execution commands and data of a processor. The register element represents a register of the processor. The control element represents controller that accesses to the memory element and/or the register. The command input means analyzes an inputted command to operate a plurality of simulation elements. The resource access analyzing means checks resource accesses of the control element to the memory element and/or the register element.

By this construction, allocation information such as a command execution address range, the resources that permit accesses, types of accesses (readout, spell-out) can be designed beforehand, and a processing against the designated allocation information can be detected. This method can detect incorrect accesses to the respective circuits using executive commands. However, in a processor including a plurality of circuits, incorrect accesses due to the congestion of data in buses caused by the simultaneous operation of the plurality of circuits, access latency occurring because other circuits are prioritized, and interrupts cannot be detected.

In a processor of recent years including a plurality of circuits, unlike the case where a single circuit is operated, accesses might occur at timings not intended by a developer due to the congestion of data in buses caused by the simultaneous operation of the plurality of circuits, access latency occurring because other circuits are prioritized, and interrupts, and incorrect accesses might be made to the circuits. Therefore, the developer requests a simulation apparatus simulating processings including those during glitches.

However, in the case of simulating processings including those during glitches, a simulation range extends and calculation amount becomes huge. As a result, the operating speed of the simulation apparatus itself slows down, and development utilizing the simulation apparatus requires time.

In the case of simplifying the system by deleting processings during glitches in order to speed up the simulation apparatus, there are problems such as incapability to check program errors.

As described above, there is a trade-off relationship between the demand for accuracy also in the processings during glitches and the operating speed of the simulation apparatus, and the present problem is that there is no method for separately using a high-speed simulation apparatus having a simplified system and a low-speed simulation apparatus for simulating processings including those during glitches similar to an actuator processor.

### SUMMARY OF THE INVENTION

In order to solve the above problems, an object of the present invention is to provide a simulation apparatus, a simulation method and a computer-readable recording medium storing a simulation program that are capable of easily detecting an incorrect access caused by the simultaneous operation of a plurality of circuits and reducing the time and developing costs required for analyses to specify the incorrect access.

One aspect of the present invention is directed to a simulation apparatus for simulating the operation of a system circuit including a plurality of circuits, comprising an access order storage for prestoring access order information representing a correct access order of data to be inputted to and outputted from simulation circuits simulating the circuits; an access monitor for obtaining information on the input and output of the data to and from the simulation circuits as access information and judging whether or not an order of obtaining the access information is correct based on the access order information stored in the access order storage; and a warning notifier for notifying a warning to a user if the order of obtaining the access information is judged to be incorrect by the access monitor.

Another aspect of the present invention is directed to a simulation method for simulating the operation of a system circuit including a plurality of circuits, comprising an access monitoring step of obtaining information on the input and output of data to and from simulation circuits as access information and judging whether or not an order of obtaining the access information is correct based on access order information stored in an access order storage and representing a correct access order of data to be inputted to and outputted from the simulation circuits; and a warning notifying step of notifying a warning to the user if the order of obtaining the access information is judged to be incorrect in the access monitoring step.

Still another aspect of the present invention is directed to a computer-readable recording medium storing a simulation program for simulating the operation of a system circuit including a plurality of circuits, the simulation program causing a computer to function as an access order storage for prestoring access order information representing a correct access order of data to be inputted to and outputted from simulation circuits simulating the circuits; an access monitor for obtaining information on the input and output of the data to and from the simulation circuits as access information and judging whether or not an order of obtaining the access information is correct based on the access order information stored in the access order storage; and a warning notifier for notifying a warning to a user if the order of obtaining the access information is judged to be incorrect by the access monitor.

According to these constructions, the access order information representing the correct access order of the data to be inputted to and outputted from the simulation circuits simulating the circuits of the system circuit are prestored in the access order storage. The information on the input and output of the data to and from the simulation circuits is obtained as the access information, and it is judged whether or not the order of obtaining the access information is correct based on the access order information stored in the access order storage. A warning is notified to the user if the order of obtaining access information is judged to be incorrect.

According to the present invention, incorrect accesses caused by the simultaneous operation of the plurality of circuits can be easily detected, and the time and developing costs required for analyses to specify the incorrect accesses can be reduced. Since a warning is notified to the user without performing an error processing in the case of an incorrect access, it is possible to increase the simulation speed, to prevent a delay in development and to shorten a development period.

### BRIEF DESCRIPTION OF THE DRAWINGS

FIG. 1 is a diagram showing the construction of a simulation apparatus according to a first embodiment.

FIG. 2 is a diagram showing the construction of a first simulation circuit of the simulation apparatus according to the first embodiment.

FIG. 3 is a table showing one example of access order information of an LCD controller.

FIG. 4 is a table showing one example of access information of the LCD controller detected by an access monitor.

FIG. 5 is a table showing one example of access order information of an image processing circuit.

FIG. 6 is a flow chart showing the operation procedure of the simulation apparatus according to the first embodiment.

FIG. 7 is a diagram showing the construction of a simulation apparatus according to a modification of the first embodiment.

FIG. 8 is a flow chart showing the operation procedure of the simulation apparatus according to the modification of the first embodiment.

FIG. 9 is a diagram showing the construction of a simulation apparatus according to a second embodiment.

FIG. 10 is a flow chart showing the operation procedure of the simulation apparatus according to the second embodiment.

FIG. 11 is a table showing an example of system access order information of the simulation apparatus according to the second embodiment.

FIG. 12 is a diagram showing the construction of a simulation apparatus according to a third embodiment.

FIG. 13 is a flow chart showing the operation procedure of the simulation apparatus according to the third embodiment.

FIG. 14 is a flow chart showing the operation procedure of a simulation apparatus according to a modification of the third embodiment.

FIG. 15 is a diagram showing the construction of a simulation apparatus according to a fourth embodiment.

FIG. 16 is a flow chart showing the operation procedure of the simulation apparatus according to the fourth embodiment.

FIG. 17 is a diagram showing the construction of a conventional simulation apparatus.

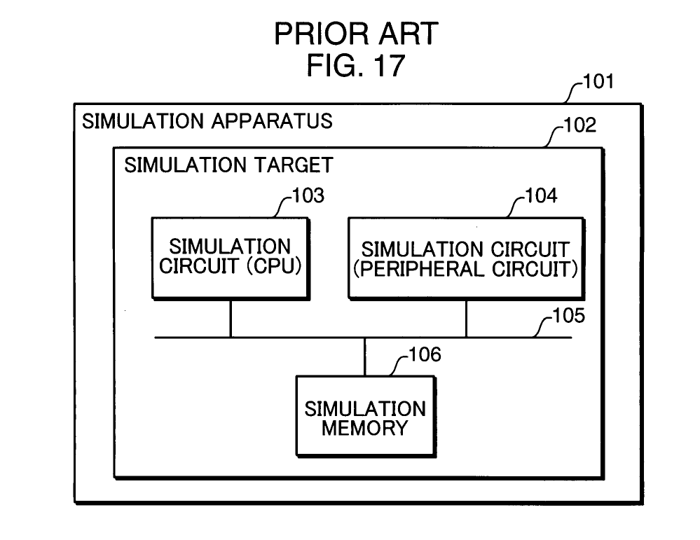

### DETAILED DESCRIPTION OF THE PREFERRED EMBODIMENTS OF THE INVENTION

Hereinafter, embodiments of the present invention are described with reference to the accompanying drawings. It should be noted that the following embodiments are merely concrete examples of the present invention and are not of such nature as to limit the technical scope of the present invention.

### First Embodiment

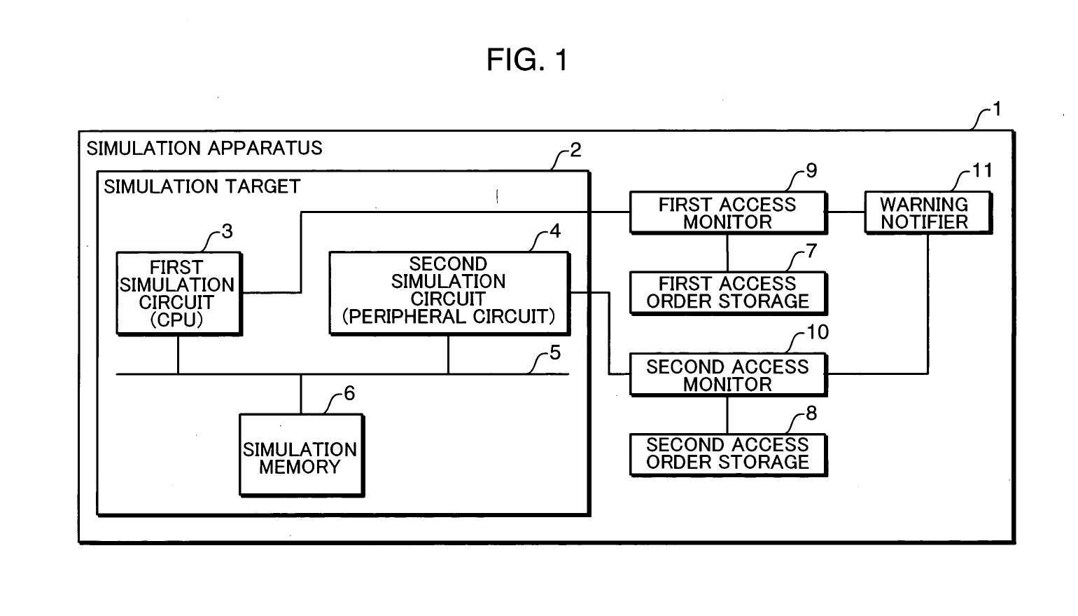

FIG. 1 is a diagram showing the construction of a simulation apparatus according to a first embodiment. A simulation apparatus 1 of FIG. 1 simulates the operation of a processor as one example of a system circuit. The simulation apparatus 1 is provided with a simulation target 2, a first access order storage 7, a second access order storage 8, a first access monitor 9, a second access monitor 10 and a warning notifier 11.

The simulation target 2 is a component similar to a processor used in an actual product and includes a first simulation circuit 3, a second simulation circuit 4, a simulation bus 5 and a simulation memory 6. The first simulation circuit 3 simulates a CPU (central processing unit). The second simulation circuit 4 simulates a peripheral circuit. The simulation bus 5 simulates a bus. The simulation memory 6 simulates a memory.

The first access order storage 7 prestores access order information defining a correct access order of data to be inputted to and outputted from the first simulation circuit 3. The second access order storage 8 prestores access order information defining a correct access order of data to be inputted to and outputted from the second simulation circuit 4.

The first access monitor 9 obtains information on the input and output of data to and from the first simulation circuit 3 as access information, and judges whether or not an order of obtaining the access information is correct based on the access order information stored in the first access order storage 7. In other words, the first access monitor 9 obtains information on the input and output of data to and from the first simulation circuit 3 as access information, and judges whether or not an order of obtaining the access information agrees with an access order represented by the access order information stored in the first access order storage 7.

The second access monitor 10 obtains information on the input and output of data to and from the second simulation circuit 4 as access information, and judges whether or not an order of obtaining the access information is correct based on the access order information stored in the second access order storage 8. In other words, the second access monitor 10 obtains information on the input and output of data to and from the second simulation circuit 4 as access information, and judges whether or not an order of obtaining the access information agrees with an access order represented by the access order information stored in the second access order storage 8.

The warning notifier 11 notifies a warning to a user if the order of obtaining the access information is judged to be incorrect by the first access monitor 9 or if the order of obtaining the access information is judged to be incorrect by the second access monitor 10. Specifically, the warning notifier 11 notifies a warning to the user if the order of obtaining the access information is judged to disagree with the prestored access information by the first access monitor 9 or if the order of obtaining the access information is judged to disagree with the prestored access information by the second access monitor 10. It should be noted that the warning notifier 11 includes, for example, a liquid crystal monitor and a warning is notified to the user by displaying, on a simulation screen, a message to the effect that the access order of the first simulation circuit 3 or the second simulation circuit 4 is incorrect.

The first access order storage 7, the second access order storage 8, the first access monitor 9, the second access monitor 10 and the warning notifier 11 are present only in the simulation apparatus, and not present in the actual system circuit. Since these functions are not added to the system circuit, there is no likelihood of increasing the cost for the system circuit.

In the first embodiment, the first access order storage 7 and the second access order storage 8 correspond to one example of an access order storage; the first access monitor 9 and the second access monitor 10 correspond to one example of an access monitor; and the warning notifier 11 corresponds to one example of a warning notifier.

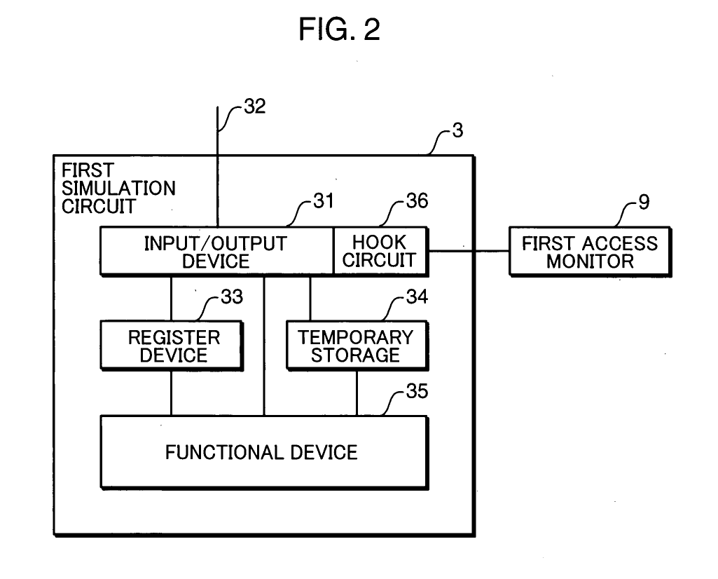

FIG. 2 is a diagram showing the construction of the simulation circuit 3 of the simulation apparatus according to the first embodiment. Since the construction of the second simulation circuit 4 is identical to that of the first simulation circuit 3, only the first simulation circuit 3 is described here.

The first simulation circuit 3 shown in FIG. 2 includes an input/output device 31, a register device 33, a temporary storage 34, a functional device 35 and a hook circuit 36. Data outputted from another simulation circuit are inputted to the input/output device 31 via an input/output bus 32, and data are outputted from the input/output device 31 to another simulation circuit via the input/output bus 32. In the case of an access from another simulation circuit, the first access monitor 9 detects this access using the hook circuit 36. The register device 33 of FIG. 2 is comprised of a plurality of registers (register group) having different functions. The temporary storage 34 is constructed by a memory or a buffer for temporarily saving data in the first simulation circuit 3. The functional device 35 is a functional device of the first simulation circuit 3.

Although the actual processor includes an error processing circuit operated when an incorrect access is made, the first and second simulation circuits 3, 4 simulate only when correct accesses stored in the access order information, but do not include simulation circuits simulating error processing circuits. Thus, no error processing is performed even if an incorrect access is made, wherefore the slow-down of the operating speed of the simulation apparatus can be prevented.

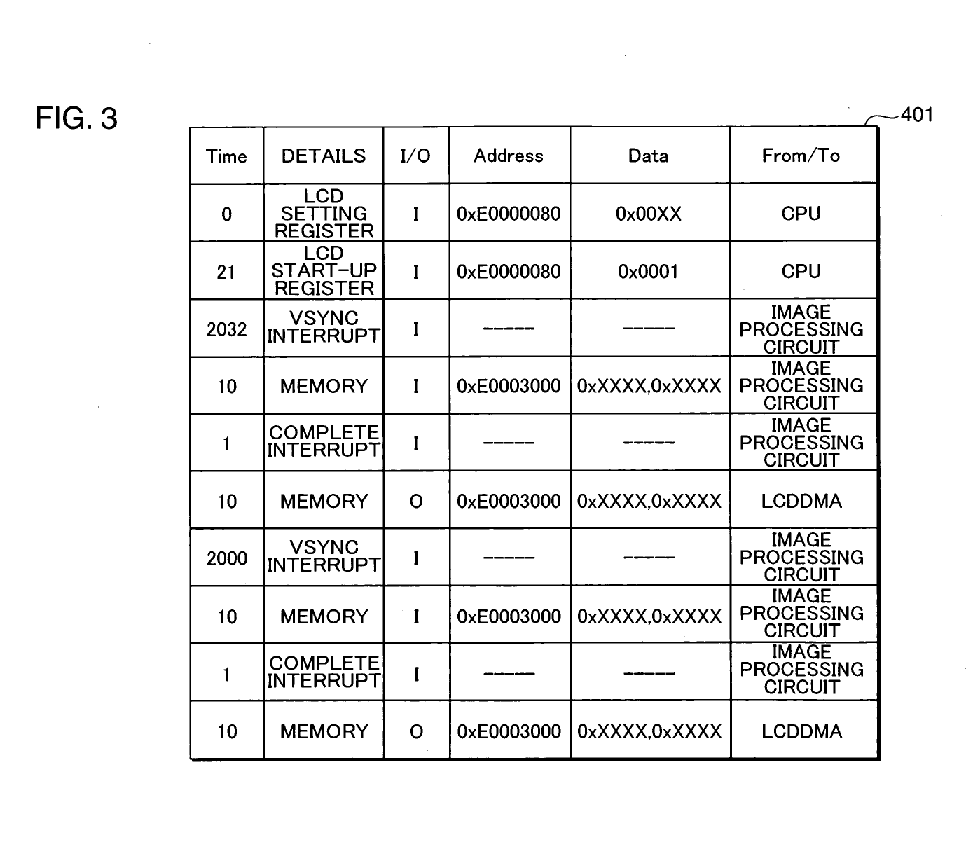

FIG. 3 is a table showing one example of access order information of an LCD (liquid crystal display) controller. In access order information 401 shown in FIG. 3, items in the first column represent waiting times from the ends of the previous access processings. An access processing having a waiting time “0” means to be a processing which is irrelevant to time and whose order can be switched with that of the previous access processing. Items in the second column represent details of the registers and the memories of the simulation circuits, interrupt instructions to the simulation circuits and the like. Each item in the third column represents whether the access is an input from another simulation circuit or an output to another simulation circuit. Each item in the fourth column represents the address of the register or the memory to which an access has been made, and each item in the fifth column represents data to be inputted or outputted. It should be noted the values of the data do not matter at positions shown by “X”. Each item in the sixth column represents an accessing end or an accessed end.

In the access order information 401, data “0x00XX” inputted from the CPU is first written at an address position “0xE0000080” of a LCD setting register. After the lapse of 21 sec. following the writing of the set value in the LCD setting register, data “0x0001” inputted from the CPU is written at an address position “0xE0000080” of an LCD start-up register. After the lapse of 2032 sec. following the writing of the data in the LCD start-up register, a VSYNC interrupt from the image processing circuit is accepted. After the lapse of 10 sec. following the VSYNC interrupt, data inputted from the image processing circuit “0xXXXX, 0xXXXX” are written at an address position “0x0003000” of the memory. Further, after the lapse of 1 sec. following the writing of the data in the memory, a complete interrupt is inputted from the image processing circuit. After the lapse of 10 sec. following the complete interrupt, the data “0xXXXX, 0xXXXX” written at the address position “0x0003000” of the memory are read out and outputted to an LCDDMA. It should be noted that the access order information may not have a table format shown in FIG. 3 and may have a state transition format.

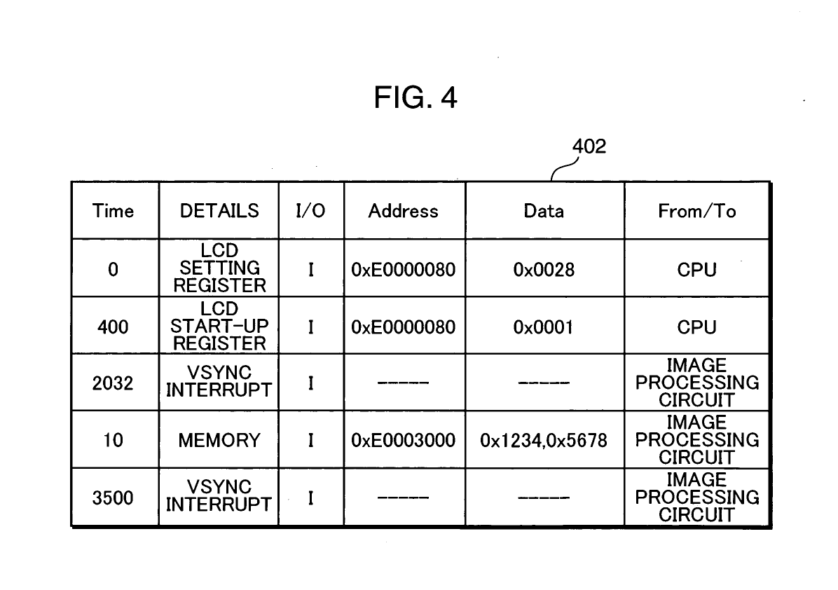

FIG. 4 is a table showing one example of the access information of the LCD controller detected by the access monitor. In access information 402 of FIG. 4, data “0x0028” inputted from the CPU is written at the address position “0xE0000080” of the LCD setting register. After the lapse of 400 sec., data “0x0001” is written at the address position “0xE0000080” of the LCD start-up register by the CPU. Subsequently, after the lapse of 2032 sec., the VSYNC interrupt is inputted from the image processing circuit. After the lapse of 10 sec. following the input of the VSYNC interrupt, data “00x1234, 0x5678” are written at the address position “00x0003000” of the memory.

A VSYNC interrupt is inputted again after the lapse of 3500 sec. following the writing of the data in the memory. Here, in the access order information 401 of FIG. 3, a complete interrupt is inputted after the lapse of 1 sec. following the writing of the data in the memory. In other words, a warning is notified to a user since the access information obtained from the hook circuit 36 disagrees with the prestored access order information.

It should be noted that the first and second access monitors 9, 10 of this embodiment judge only whether or not the pieces of the access order information are in agreement, but do not judge whether or not the elapsed times (waiting times) from the previous access processings are in agreement. For example, the data is inputted to the LCD start-up register after the lapse of 21 sec. following the data input to the LCD setting register in the access order information of FIG. 3, whereas the data is inputted to the LCD start-up register after the lapse of 400 sec. in the access information of FIG. 4. In other words, even though waiting times differ, a correct access is judged and no warning is notified to the user if the access orders are in agreement.

As described above, judgment is only made as to whether or not access orders are in agreement in this embodiment, but the present invention is not particularly limited thereto. The first and second access monitors 9, 10 may judge whether or not the orders of obtaining the access information agree with the access orders represented by the access order information stored in the first and second access order storages 7, 8 and whether or not time information contained in the access information agrees with time information contained in the access order information. The warning notifier 11 may notify a warning to the user if the order of obtaining the access information is judged to disagree with the prestored access order by the first or second access monitors 9 or 10 or if the time information contained in the access information is judged to disagree with the one contained in the access order information although the order of the obtaining the access information agrees with the prestored access order.

In such a case, accesses can be more accurately detected since judgment is made not only as to whether or not the access orders are in agreement, but also as to whether or not the elapsed times from the previous access processings are in agreement. Therefore, simulation accuracy can be improved.

The first and second access monitors 9, 10 may judge whether or not the orders of obtaining the access information agree with the access orders represented by the access order information stored in the first and second access order storages 7, 8 and whether or not the data contained in the access information agrees with the one contained in the access order information. The warning notifier 11 may notify a warning to the user if the order of obtaining the access information is judged to disagree with the prestored access order by the first or second access monitors 9 or 10 or if the data contained in the access information is judged to disagree with the one contained in the access order information although the order of the obtaining the access information agrees with the prestored access order.

In such a case, accesses can be more accurately detected since judgment is made not only as to whether or not the access orders are in agreement, but also as to whether or not the data contained in the access information are in agreement. Therefore, simulation accuracy can be improved.

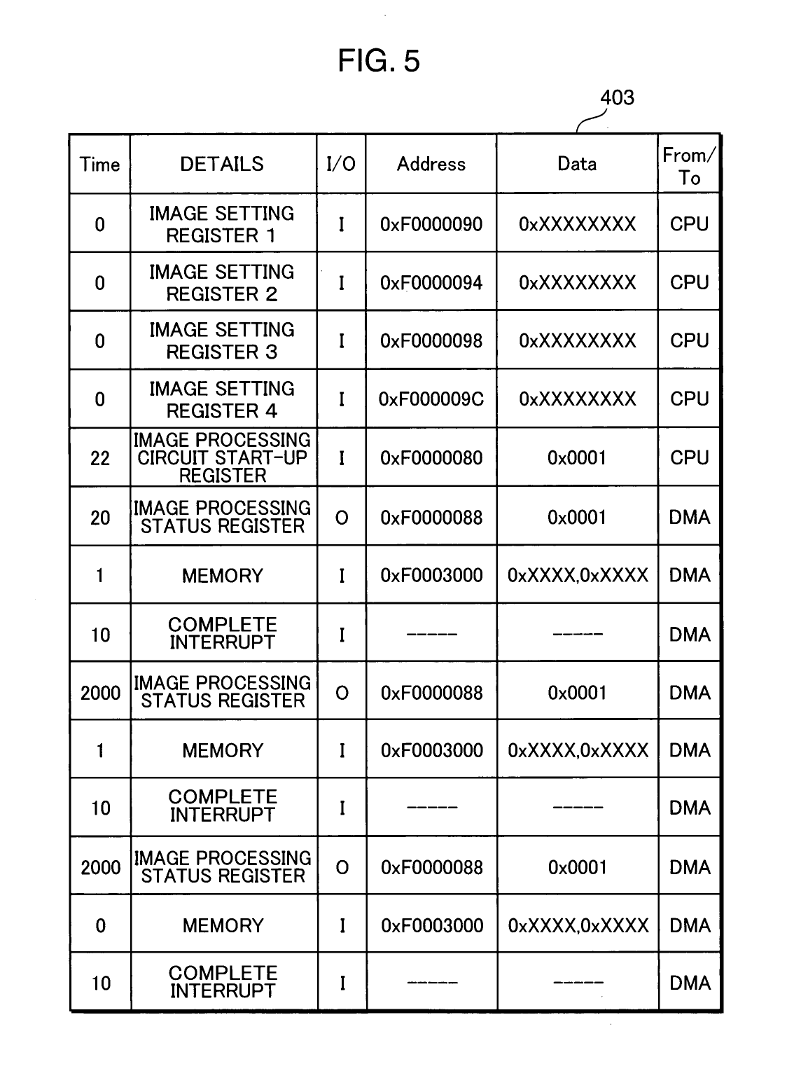

FIG. 5 is a table showing one example of access order information of the image processing circuit. In access order information 403 shown in FIG. 5, data (set value) inputted from the CPU is written in each image setting register. After the lapse of 22 sec., data “0x0001” inputted from the CPU is written in an image processing circuit start-up register. Subsequently, after the lapse of 20 sec., data is read out from an image processing status register and notification to the effect that the data can be written is given to the DMA. After the lapse of 1 sec., the DMA writes data in the memory. Upon completing the writing of the data in the memory by the DMA, a complete interrupt is inputted from the DMA. After the lapse of 2000 sec. following the input of the complete interrupt, the data is read again from the image processing status register and notification to the effect that the data can be written is given again to the DMA. It should be noted that the access order information may not have a table format shown in FIG. 5 and may have a state transition format.

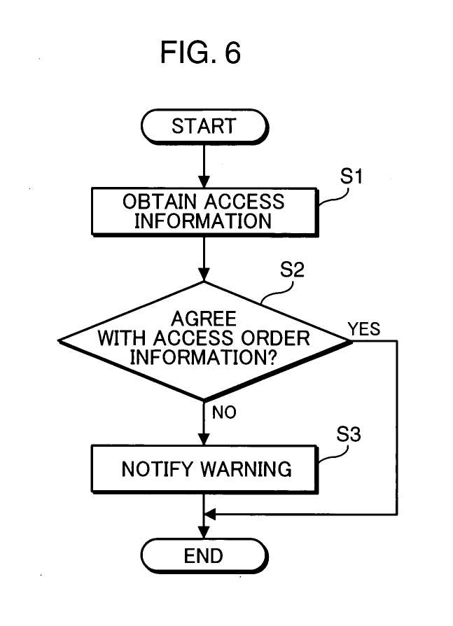

Next, the operation of the simulation apparatus 1 according to the first embodiment is described. FIG. 6 is a flow chart showing the operation procedure of the simulation apparatus 1 according to the first embodiment. A case where accesses to the first simulation circuit 3 are monitored by the first access monitor 9 is described below.

First, in Step S1, the first access monitor 9 obtains the access information of the first simulation circuit 3 via the hook circuit 36 of the first simulation circuit 3. It should be noted that the access information includes waiting time information representing the elapsed time from the previous access processing, input/output information representing whether the access is an input or an output, address information representing the stored position of data in the register or the memory, data to be written in or read out, and information representing an accessing end or an accessed end.

Subsequently, in Step S2, the first access monitor 9 judges whether or not the access information obtained from the first simulation circuit 3 agrees with the access order information prestored in the first access order storage 7. Here, if the access information is judged to agree with the access order information (YES in Step S2), this routine ends and the simulation apparatus 1 causes the first simulation circuit 3 to perform a simulation operation.

On the other hand, if the access information is judged to disagree with the access order information (NO in Step S2), the warning notifier 11 notifies a warning to the user in Step S3. In other words, the warning notifier 11 gives, to the user, notification to the effect that an access in disagreement with the predetermined correct access order has occurred during the simulation operation of the first simulation circuit 3.

In the simulation apparatus 1 according to the first embodiment, the first access monitor 9 or the second access monitor 10 judges whether or not an access from another simulation circuit agrees with the access order information stored in the first access order storage 7 or the second access order storage 8, and the warning notifier 11 notifies a warning to the user if the access is judged to disagree. Thus, incorrect accesses to the circuits can be detected by the simulation apparatus 1 according to the first embodiment, and a reduction in the operating speed of the simulation apparatus can be prevented by suppressing the simulation range to a minimal range.

As described above, the pieces of the access order information representing the correct access orders of the data to be inputted to and outputted from the first and second simulation circuits 3, 4 simulating the circuits of the processor are prestored in the first and second access order storages 7, 8. The information on the input and output of data to and from the first and second simulation circuits 3, 4 are obtained as the access information, and judgment is made as to whether or not the orders of obtaining the access information agree with the access orders represented by the access order information stored in the first and second access order storages 7, 8. A warning is notified to the user if the order of obtaining the access information is judged to disagree with the prestored access order.

Accordingly, incorrect accesses caused by the simultaneous operation of a plurality of circuits can be easily detected, and the time and costs required for analyses to specify the incorrect accesses can be reduced. Since a warning is notified to the user without performing an error processing in the case of an incorrect access, it is possible to increase the simulation speed, to prevent a delay in development and to shorten a development period.

The access order information of each of the first and second simulation circuits 3, 4 is prestored in the corresponding one of the first and second access order storages 7, 8. The access information is obtained for each of the first and second simulation circuits 3, 4, and whether or not the order of obtaining the access information agrees with the access order represented by the access order information stored in the first and second access order storages 7, 8 is judged for each of the first and second simulation circuits 3, 4. A warning is notified to the user if the order of obtaining the access information is judged to disagree with the prestored access order.

Accesses can be detected for each of the first and second simulation circuits 3, 4 since whether or not the order of obtaining the access information agrees with the access order represented by the access order information stored in the first and second access order storages 7, 8 is judged for each of the first and second simulation circuits 3, 4.

Since the access information of each of the first and second simulation circuits 3, 4 is prestored in the corresponding one of the first and second access order storages 7, 8, the stored access information of each simulation circuit 3, 4 can be read out and presented to the user.

Although a warning is notified to the user and the simulation ends when the access information is detected to disagree with the access order information in the first embodiment, the present invention is limited thereto. The access information of each simulation circuit may be stored until the simulation operation of the simulation target is completed, and the access information in disagreement with the access order information may be extracted from the stored pieces of access information after the simulation operation is completed.

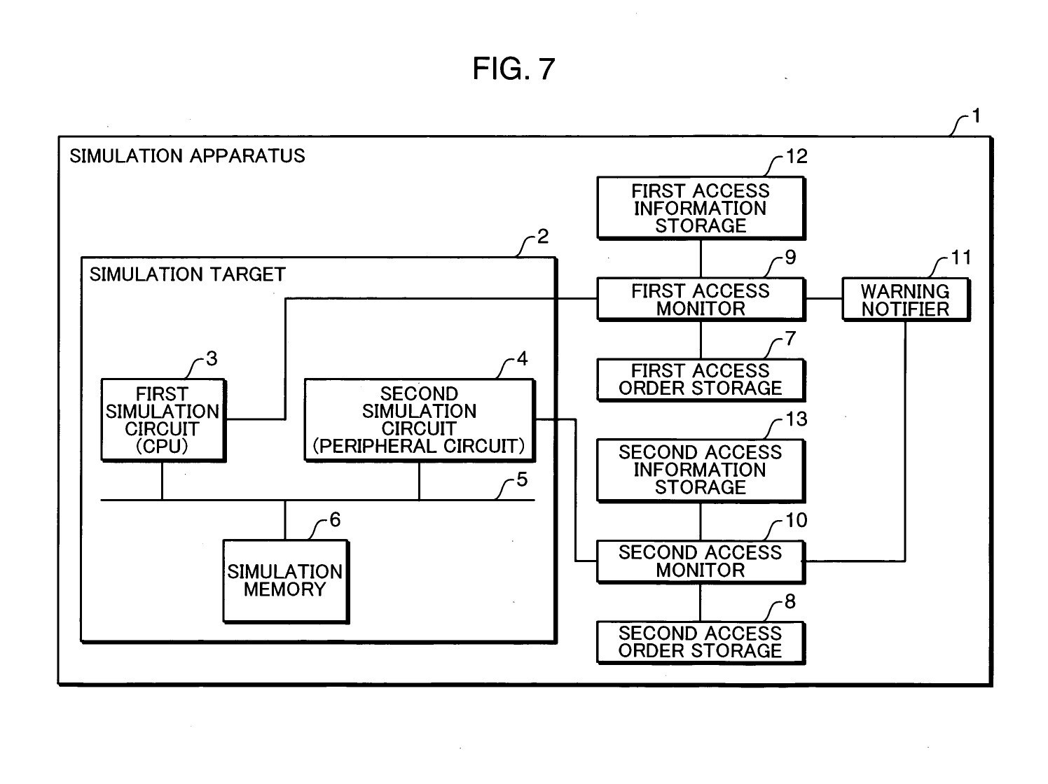

FIG. 7 is a diagram showing the construction of a simulation apparatus according to a modification of the first embodiment and differs from FIG. 1 in including a first access information storage 12 and a second access information storage 13.

The first access information storage 12 stores pieces of access information obtained from the first simulation circuit 3 in an order of inputting and outputting data. A first access monitor 9 stores the access information obtained from the first simulation circuit 3 in the first access information storage 12. The second access information storage 13 stores pieces of access information obtained from the second simulation circuit 4 in an order of inputting and outputting data. A second access monitor 10 stores the access information obtained from the second simulation circuit 4 in the second access information storage 13.

It should be noted that the first and second access information storages 12, 13 correspond to one example of an access information storage in the modification of the first embodiment.

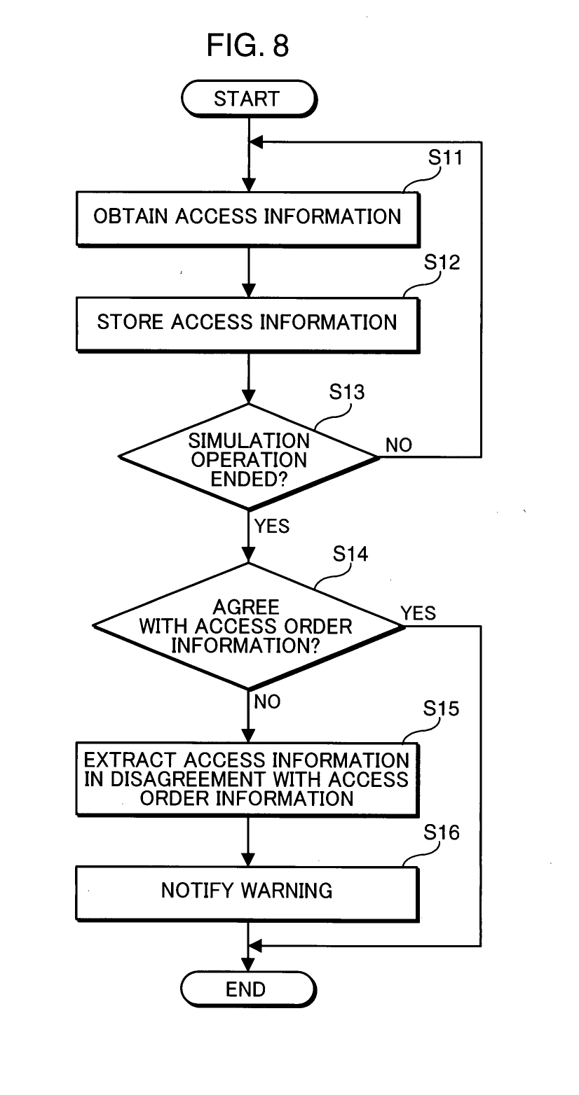

Next, the operation of the simulation apparatus 1 according to the modification of the first embodiment is described. FIG. 8 is a flow chart showing the operation procedure of the simulation apparatus according to the modification of the first embodiment. A case where accesses to the first simulation circuit 3 are monitored by the first access monitor 9 is described below.

First, in Step S11, the first access monitor 9 obtains the access information of the first simulation circuit 3 via the hook circuit 36 of the first simulation circuit 3. Subsequently, in Step S12, the first access monitor 9 stores the access information obtained from the first simulation circuit 3 in the first access information storage 12. It should be noted that the first access information storage 12 stores pieces of the access information in an order of inputting or outputting data.

Subsequently, in Step S13, the first access monitor 9 judges whether or not the simulation operation of the simulation target 2 has ended. Here, if the simulation operation of the simulation target 2 is judged not to have ended yet (NO in Step S13), this routine returns to Step S11 and the first access monitor 9 further obtains access information. In this way, the operations of Steps S11 to S13 are repeatedly performed to obtain a plurality of pieces of access information of the first simulation circuit 3 until the simulation operation ends in the modification of the first embodiment.

On the other hand, if the simulation operation of the simulation target 2 is judged to have ended (YES in Step S13), in Step S14, the first access monitor 9 judges whether or not the plurality of pieces of access information stored in the first access information storage 12 agree with the access order information prestored in the first access order storage 7. Here, this routine ends if the pieces of access information are judged to agree with the access order information (YES in Step S14).

On the other hand, if the pieces of access information are judged to disagree with the access order information (NO in Step S14), in Step S15, the first access monitor 9 extracts the access information judged to disagree with the access order information from the first access information storage 12 out of the plurality of pieces of access information.

Subsequently, in Step S16, the warning notifier 11 notifies a warning to a user. In other words, the warning notifier 11 gives, to the user, notification to the effect that an access in disagreement with the predetermined correct access order has occurred during the simulation operation of the first simulation circuit 3. At this time, the warning notifier 11 notifies the access information extracted from the first access information storage 12 to the user.

In this way, the access information judged to disagree with the prestored access orders is read from the first and second access information storages 12, 13, and the read access information is notified to the user. Therefore, the user can easily know the cause of occurrence of an incorrect access by confirming the notified access information.

Further, the access information is obtained from each of the simulation circuits 3, 4, and the obtained access information is stored in the corresponding one of the first and second access information storages 12, 13. After the simulation operations of the first and second simulation circuits 3, 4 end, it is judged whether or not the order of obtaining the access information stored in the first and second access information storages 12, 13 agree with the access orders represented by the access order information stored in the first and second access order storages 7, 8.

The pieces of access information obtained until the simulation operations of the first and second simulation circuits 3, 4 end are stored, and it is judged whether or not the orders of obtaining the access information agree with the access orders represented by the pieces of the access order information after the simulation operations of the first and second simulation circuits 3, 4 end. Therefore, it is possible to notify a warning to the user upon detecting an incorrect access after the simulation operations of the first and second simulation circuits 3, 4 are performed to the end, instead of notifying a warning to the user upon detecting an incorrect access during the simulation operations of the first and second simulation circuits 3, 4.

### Second Embodiment

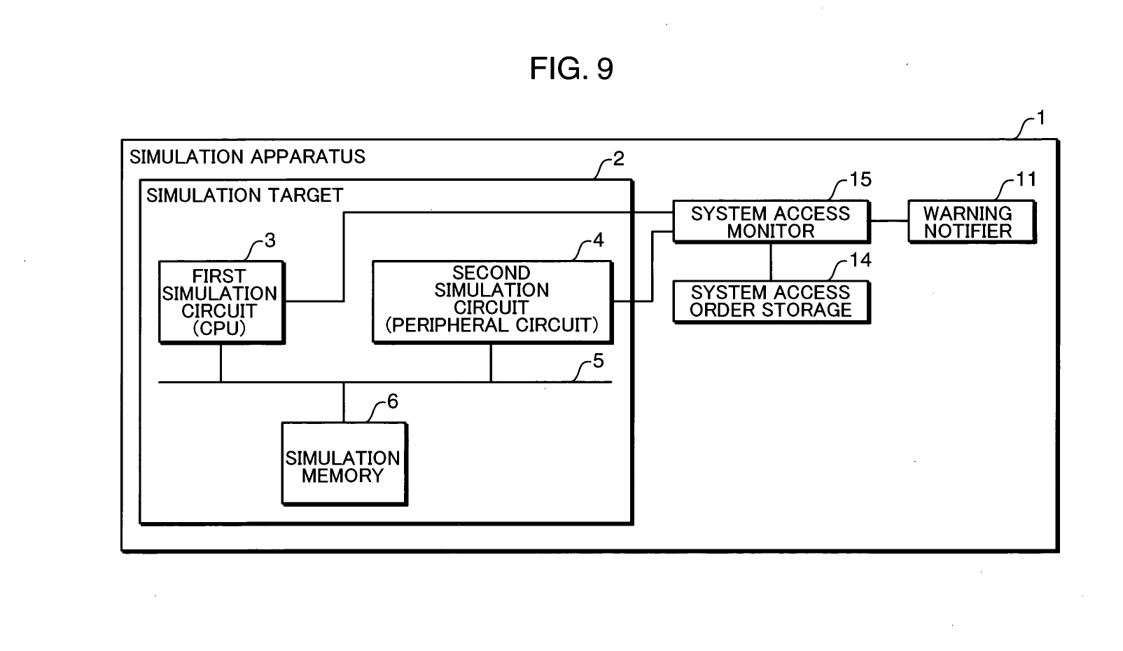

Next, a simulation apparatus according to a second embodiment is described. FIG. 9 is a diagram showing the construction of a simulation apparatus according to the second embodiment, and differs from FIG. 1 in that the first and second access order storages 7, 8 and the first and second access monitors 9, 10 are not provided, but a system access order storage 14 and a system access monitor 15 are provided. Other components are the same as in FIG. 1.

The system access order storage 14 prestores system access order information defining a correct access order of data to be inputted to and outputted from a plurality of simulation circuits in a simulation target 2. The first and second access order storages 7, 8 of the first embodiment store the correct access orders to the individual simulation circuits, whereas the system access order storage 14 stores a correct access order to the entire simulation target 2 including a plurality of simulation circuits.

The system access monitor 15 monitors whether or not the access order of the respective simulation circuits constituting the simulation target 2 agrees with the system access order stored in the system access order storage 14. The first and second access monitors 9, 10 of the first embodiment monitors accesses to the individual simulation circuits, whereas the system access monitor 15 monitors accesses to the entire simulation target 2 including a plurality of simulation circuits.

It should be noted that, in the second embodiment, the system access order storage 14 corresponds to one example of an access order storage and the system access monitor 15 corresponds to one example of an access monitor.

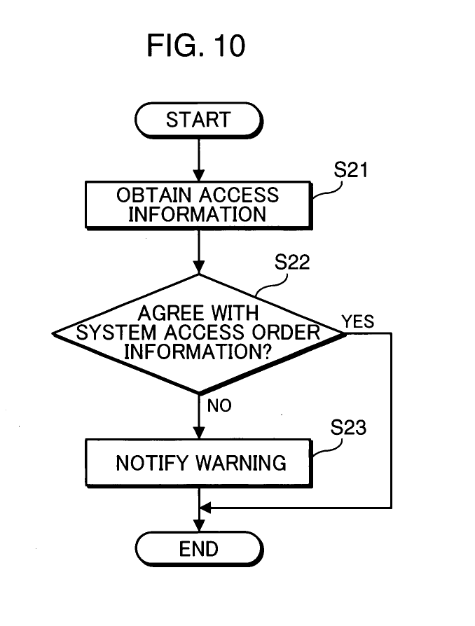

Next, the operation of the simulation apparatus 1 according to the second embodiment is described. FIG. 10 is a flow chart showing the operation procedure of the simulation apparatus 1 according to the second embodiment. First, in Step S21, the system access monitor 15 obtains the access information of the first or second simulation circuit 3 or 4 via a hook circuit of the first or second simulation circuit 3 or 4. It should be noted that the access information includes waiting time information representing the elapsed time from the previous access processing, simulation circuit information representing the type of the simulation circuit, input/output information representing whether the access is an input or an output, address information representing the stored position of data in a register or a memory, data to be written in or read out, and information representing an accessing end or an accessed end.

Subsequently, in Step S22, the system access monitor 15 judges whether or not the access information obtained from the first or second simulation circuit 3 or 4 agrees with the system access order information prestored in the system access order storage 14. Here, if the access information is judged to agree with the system access order information (YES in Step S22), this routine ends and the simulation apparatus 1 causes the first and second simulation circuits 3 and 4 to perform simulation operations.

On the other hand, if the access information is judged to disagree with the system access order information (NO in Step S22), the warning notifier 11 notifies a warning to the user in Step S23. In other words, the warning notifier 11 gives, to the user, notification to the effect that an access in disagreement with the predetermined correct system access order has occurred during the simulation operation of the first or second simulation circuit 3 or 4.

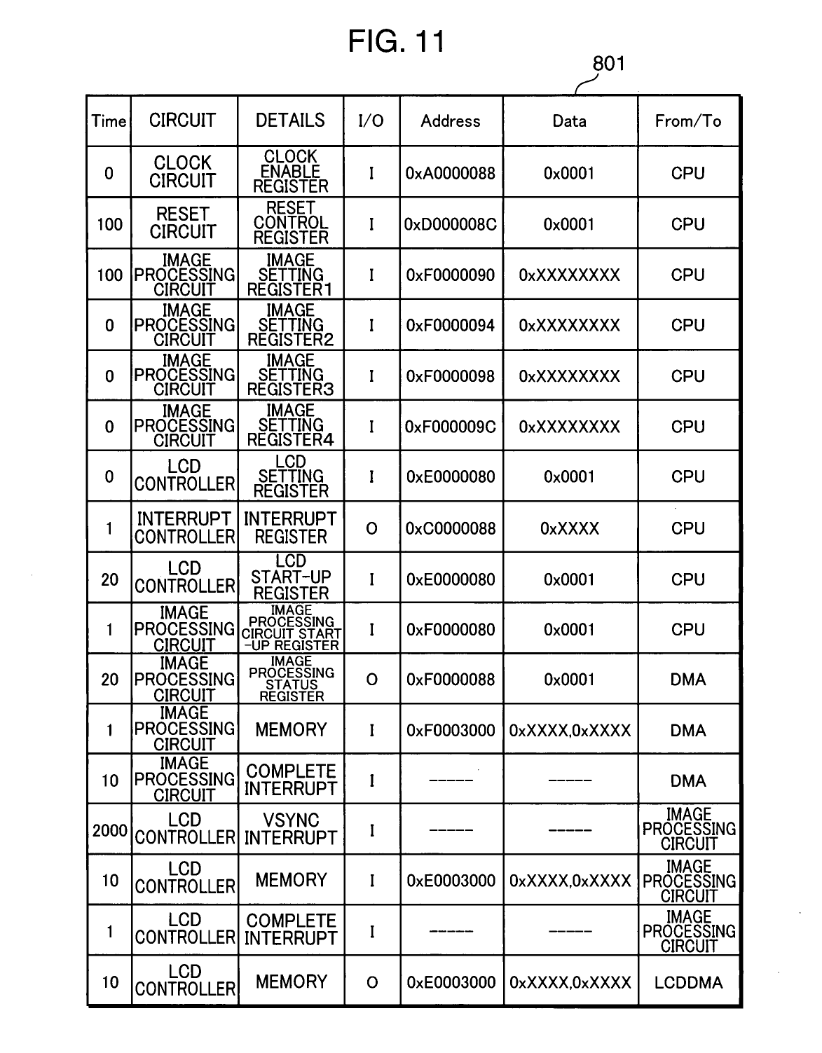

FIG. 11 is a table showing one example of system access order information of the simulation apparatus 1 according to the second embodiment. In system access order information 801 shown in FIG. 11, items in the first column represent waiting times from the ends of the previous access processings. An access processing having a waiting time “0” means to be a processing which is irrelevant to time and whose order can be switched with that of the previous access processing. Items in the second column represent the simulation circuits. It should be noted that the simulation circuits in FIG. 11 include a CPU, a DMA, an LCDDMA, a clock circuit, a reset circuit, an image processing circuit, an LCD controller and an interrupt controller.

Items in the third column represent details of the registers and the memories of the simulation circuits, interrupt instructions to the simulation circuits and the like. Each item in the fourth column represents whether an access is an input from another simulation circuit or an output to another simulation circuit. Each item in the fifth column represents the address of the register or the memory to which an access has been made, and each item in the sixth column represents data to be inputted or outputted. It should be noted that the values of the data do not matter at positions shown by “X”. Each item in the seventh column represents an accessing end or an accessed end.

In the system access order information 801, data inputted from the CPU is first written in a clock enable register of the clock circuit. Thereafter, data inputted from the CPU is written in a reset control register of the reset circuit, and data (set values) inputted from the CPU are written in image setting resistors of the image processing circuit and an LCD setting register of the LCD controller. At this time, the respective settings having the waiting time of “0” may be switched in order. After the lapse of 1 sec. following the setting in the image processing circuit and the LCD controller, data from the CPU is written in an interrupt register of the interrupt controller, and the LCD controller and the image processing circuit are started in sequence. Thereafter, data is inputted from the DMA to the image processing circuit, which in turn applies an image processing and inputs the processed data to the LCD controller. It should be noted that the system access order information may not have a table format shown in FIG. 11 and may have a state transition format.

In the simulation apparatus 1 according to the second embodiment, the system access monitor 15 judges whether or not pieces of the access information of the simulation circuits agree with the system access order information stored in the system access order storage 14, and the warning notifier 11 notifies a warning to the user if they are judged to disagree. Accordingly, incorrect accesses due to access latency occurring because the congestion of data in buses caused by the simultaneous operation of a plurality of circuits and other circuits are prioritized, and interrupts can be detected by the simulation apparatus 1 according to the second embodiment, and a reduction in the operating speed of the simulation apparatus can be prevented by suppressing the simulation range to a minimal range.

As described above, the access order information representing the correct access order of data to be inputted to and outputted from the first and second simulation circuits 3, 4 is prestored in the system access order storage 14. The access information is obtained from the first and second simulation circuits 3, 4 and judgment is made as to whether or not the order of obtaining the access information agrees with the access order represented by the access order information stored in the system access order storage 14. A warning is notified to the user if the order of obtaining the access information is judged to disagree with the prestored access information.

Since it is judged whether or not the order of obtaining the access information from the first and second simulation circuits 3, 4 agrees with the access order represented by the access order information stored in the system access order storage 14, it is possible to detect accesses made to the entire simulation target 2 constituting the first and second simulation circuits 3, 4, instead of detecting accesses for each of the first and second simulation circuits 3, 4.

### Third Embodiment

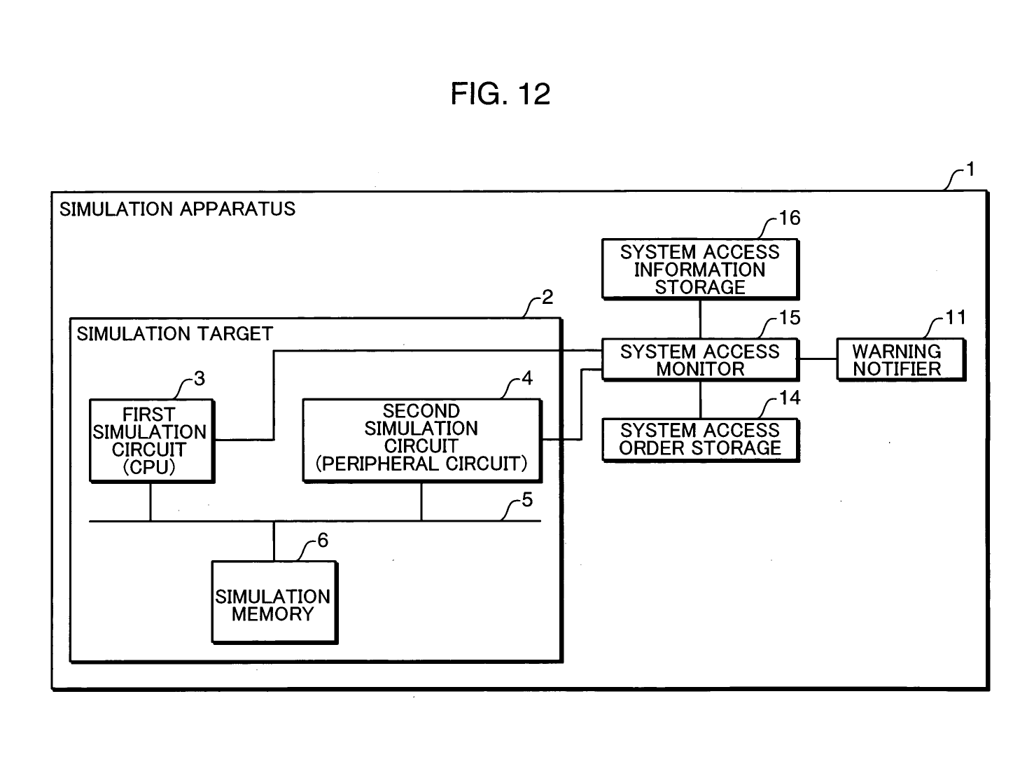

Next, a simulation apparatus according to a third embodiment is described. FIG. 12 is a diagram showing the construction of a simulation apparatus according to the third embodiment, and differs from FIG. 9 in including a system access information storage 16. Other components are the same as in FIG. 9. The system access information storage 16 stores access information obtained from first and second simulation circuits 3, 4. A system access monitor 15 stores the access information obtained from the first and second simulation circuits 3, 4 in the system access information storage 16.

It should be noted that the system access information storage 16 corresponds to one example of an access information storage in the third embodiment.

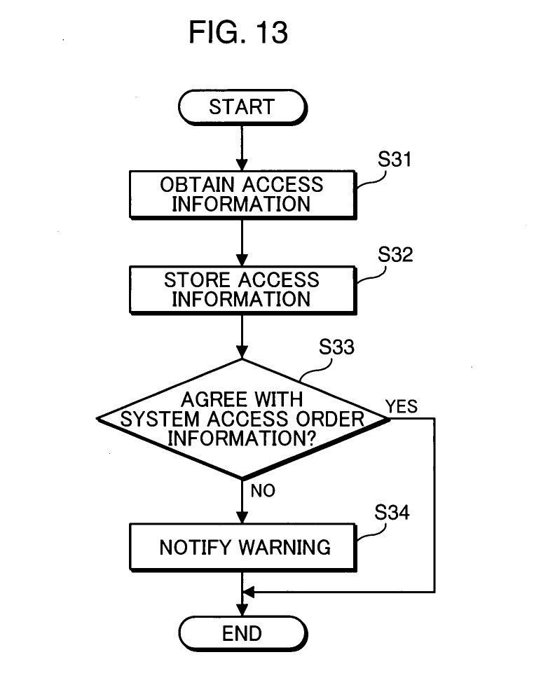

Next, the operation of the simulation apparatus 1 according to the third embodiment is described. FIG. 13 is a flow chart showing the operation procedure of the simulation apparatus 1 according to the third embodiment. This operation procedure differs from that of the second embodiment shown in FIG. 10 in that Step S32 is added. Operations in Step S31, S33 are the same as in Steps S21, S22 of FIG. 10.

In Step S32, the system access monitor 15 stores the access information obtained from the first or second simulation circuit 3 or 4 in the system access information storage 16.

If the access information is judged to disagree with the system access order information (NO in Step S33), a warning notifier 11 notifies a warning to a user in Step S34. In other words, the warning notifier 11 gives, to the user, notification to the effect that an access in disagreement with the predetermined correct system access order has occurred during the simulation operation of the first or second simulation circuit 3 or 4. At this time, the warning notifier 11 reads the access information stored in the system access information storage 16 and notifies the read access information to the user.

In the simulation apparatus 1 according to the third embodiment, the system access monitor 15 judges whether or not the access information of the simulation circuits agrees with the system access order information stored in the system access order storage 14 after the system access information storage 16 stores the access information of the simulation circuits, and the warning notifier 11 notifies a warning to the user if the access information is judged to disagree. Accordingly, the access information of the simulation circuit is stored, and this access information is presented to the user if it disagrees with the system access order information. Therefore, the cause of occurrence of an incorrect access can be easily specified.

Since the access information obtained from the first and second simulation circuits 3, 4 is stored in the system access information storage 16 in this way, the stored access information of the first and second simulation circuits 3, 4 can be read out and presented to the user.

Further, since the access information judged to disagree with the prestored access order is read from the system access information storage 16 and the read access information is notified to the user, the user can easily know the cause of occurrence of an incorrect access by confirming the notified access information.

In the third embodiment, the access information is notified to the user together with a warning and the simulation ends when the access information is detected to disagree with the access order information. However, the present invention is not limited thereto. The access information of each simulation circuit is stored until the simulation operation of the simulation target is completed, and the access information in disagreement with the system access order information may be extracted from the stored pieces of access information after the simulation operation is completed.

The construction of a simulation apparatus according to a modification of the third embodiment is the same as the simulation apparatus of the third embodiment shown in FIG. 12. Thus, the modification of the third embodiment is described with reference to the simulation apparatus shown in FIG. 12.

The system access information storage 16 stores the access information obtained from the first or second simulation circuit 3, 4 in an order of inputting and outputting data. The system access monitor 15 stores the access information obtained from the first or second simulation circuit 3 or 4 in the system access information storage 16.

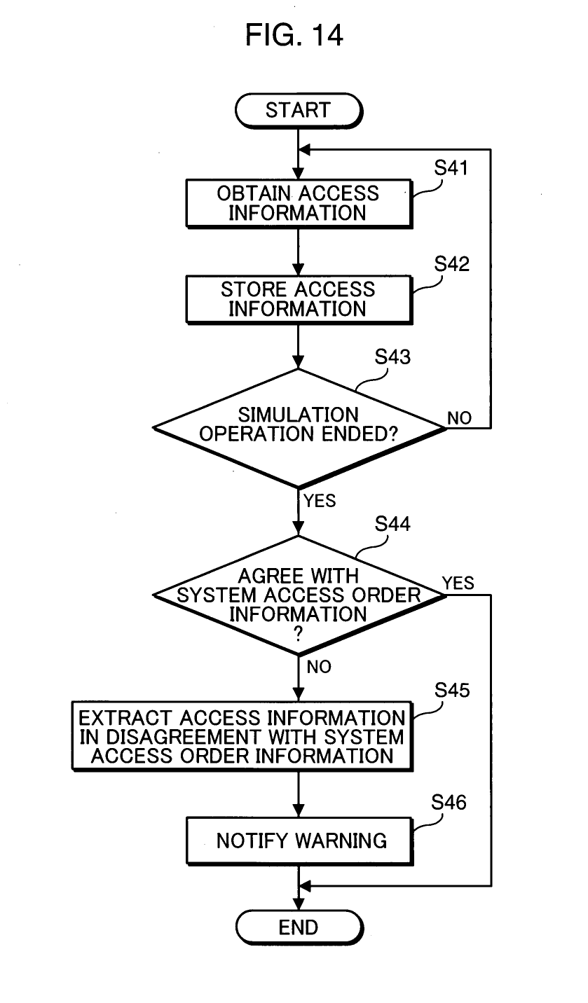

Next, the operation of the simulation apparatus 1 according to the modification of the third embodiment is described. FIG. 14 is a flow chart showing the operation procedure of the simulation apparatus according to the modification of the third embodiment.

First, in Step S41, the system access monitor 15 obtains the access information of the first or second simulation circuit 3 or 4 via a hook circuit of the first or second simulation circuit 3 or 4. Subsequently, in Step S42, the system access monitor 15 stores the access information obtained from the first or second simulation circuit 3 or 4 in the system access information storage 16. It should be noted that the system access information storage 16 stores pieces of the access information in an order of inputting or outputting data.

Subsequently, in Step S43, the system access monitor 15 judges whether or not the simulation operation of the simulation target 2 has ended. Here, if the simulation operation of the simulation target 2 is judged not to have ended yet (NO in Step S43), this routine returns to Step S41 and the system access monitor 15 further obtains access information. In this way, the operations of Steps S41 to S43 are repeatedly performed to obtain a plurality of pieces of access information of the first and second simulation circuit 3, 4 until the simulation operation ends in the modification of the third embodiment.

On the other hand, if the simulation operation of the simulation target 2 is judged to have ended (YES in Step S43), in Step S44, the system access monitor 15 judges whether or not the plurality of pieces of access information stored in the system access information storage 16 agree with the access order information prestored in the system access order storage 14. Here, the routine ends if the pieces of access information are judged to agree with the access order information (YES in Step S44).

On the other hand, if the pieces of access information are judged to disagree with the access order information (NO in Step S44), in Step S45, the system access monitor 15 extracts the access information judged to disagree with the system access order information from the system access information storage 16 out of the plurality of pieces of access information.

Subsequently, in Step S46, the warning notifier 11 notifies a warning to a user. In other words, the warning notifier 11 gives, to the user, notification to the effect that an access in disagreement with the predetermined correct access order has occurred during the simulation operations of the first and second simulation circuits 3, 4. At this time, the warning notifier 11 notifies the access information extracted from the system access information storage 16 to the user.

In this way, the access information is obtained from the first and second simulation circuits 3, 4, and the obtained access information is stored in the system access information storage 16. It is judged whether or not the order of obtaining the pieces of access information stored in the system access information storage 16 agrees with the access order represented by the access order information stored in the system access order storage 14 after the simulation operations of the first and second simulation circuits 3, 4 end.

The pieces of access information obtained until the simulation operations of the first and second simulation circuits 3, 4 end are stored, and it is judged whether or not the order of obtaining the access information agrees with the access order represented by the access order information after the simulation operations of the first and second simulation circuits 3, 4 end. Therefore, it is possible to notify a warning to the user upon detecting an incorrect access after the simulation operations of the first and second simulation circuits 3, 4 are performed to the end, instead of notifying a warning to the user upon detecting an incorrect access during the simulation operations of the first and second simulation circuits 3, 4.

### Fourth Embodiment

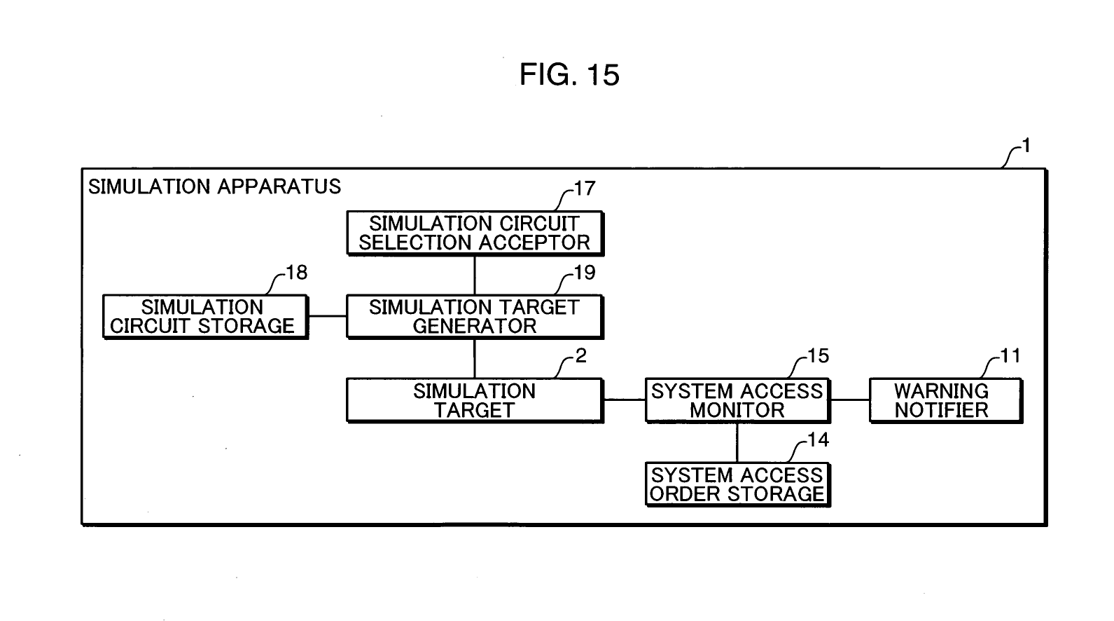

Next, a simulation apparatus according to a fourth embodiment is described. FIG. 15 is a diagram showing the construction of a simulation apparatus according to the fourth embodiment. The simulation apparatus 1 shown in FIG. 15 is provided with a warning notifier 11, a system access order storage 14, a system access monitor 15, a simulation circuit selection acceptor 17, a simulation circuit storage 18 and a simulation target generator 19. It should be noted that the constructions of the warning notifier 11, the system access order storage 14 and the system access monitor 15′ are the same as in the third embodiment and, accordingly, are not described.

The simulation circuit selection acceptor 17 accepts the selection of a simulation circuit by a user. The simulation circuit storage 18 stores a plurality of types of simulation circuits compiled into a database. The simulation target generator 19 reads a simulation circuit corresponding to the simulation circuit selected by the simulation circuit selection acceptor 17 from the simulation circuit storage 18, and generates a simulation target 2 constituted by at least one simulation circuit.

In the fourth embodiment, the simulation circuit storage 18 corresponds to one example of a simulation circuit storage, the simulation circuit selection acceptor 17 corresponds to one example of a simulation circuit selection acceptor, and the simulation target generator 19 corresponds to one example of a simulation system circuit generator.

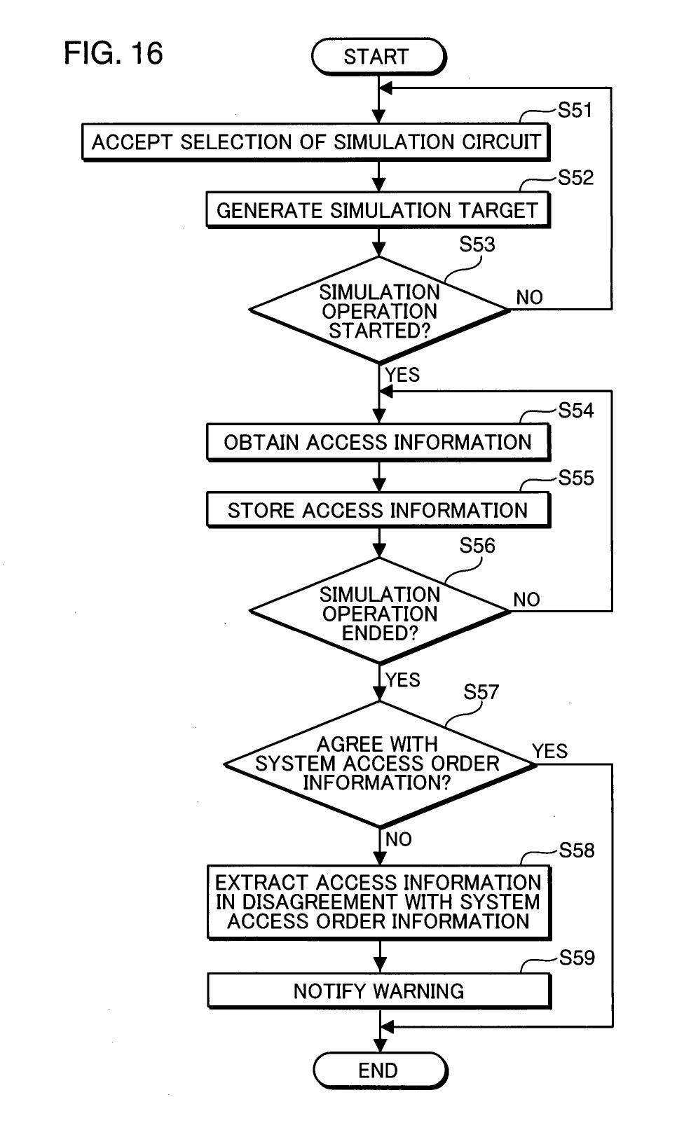

Next, the operation of the simulation apparatus 1 according to the fourth embodiment is described. FIG. 16 is a flow chart showing the operation procedure of the simulation apparatus according to the fourth embodiment.

First, in Step S51, the simulation circuit selection acceptor 17 accepts the selection of the simulation circuit by the user. Specifically, the simulation circuit selection acceptor 17 causes an unillustrated display device to display selectable simulation circuits stored in the simulation circuit storage 18. The simulation circuit selection acceptor 17 accepts the selection of the simulation circuit desired by the user by means of an unillustrated input device.

Subsequently, in Step S52, the simulation target generator 19 reads the simulation circuit corresponding to the simulation circuit selected by the simulation circuit selection acceptor 17 from the simulation circuit storage 18, and generates the simulation target 2 constituted by at least one simulation circuit.

Subsequently, in Step S53, the system access monitor 15 judges whether or not to start a simulation operation. Here, if it is judged not to start the simulation operation (NO in Step S53), this routine returns to Step S51 to accept the selection of the simulation circuit again.

On the other hand, if it is judged to start the simulation operation (YES in Step S53), this routine proceeds to Step S54. It should be noted that the operations in Steps S54 to S59 are the same as in Steps S41 to S46 shown in FIG. 14 and, accordingly, are not described here.

As described above, a plurality of simulation circuits are prestored in the simulation circuit storage 18. The selection of the simulation circuit by the user is accepted; the simulation circuit corresponding to the simulation circuit, the selection of which was accepted, is extracted from the simulation circuit storage 18; and the simulation target 2 constituted by the extracted simulation circuit is generated. Subsequently, information on the input and output of data to and from the simulation circuit constituting the simulation target 2 is obtained as access information, and it is judged whether or not an order of obtaining pieces of access information agrees with an access order represented by access order information stored in the system access order storage 14.

Since a plurality of simulation circuits are selected to generate the simulation target 2 to be simulated, it is possible to simulate the simulation target 2 desired by the user, instead of simulating the predetermined simulation target 2. Therefore, versatility can be improved.

The specific embodiments described above mainly contain inventions having the following constructions.

One aspect of the present invention is directed to a simulation apparatus for simulating the operation of a system circuit including a plurality of circuits, comprising an access order storage for prestoring access order information representing a correct access order of data to be inputted to and outputted from simulation circuits simulating the circuits; an access monitor for obtaining information on the input and output of the data to and from the simulation circuits as access information and judging whether or not an order of obtaining the access information is correct based on the access order information stored in the access order storage; and a warning notifier for notifying a warning to a user if the order of obtaining the access information is judged to be incorrect by the access monitor.

Another aspect of the present invention is directed to a simulation method for simulating the operation of a system circuit including a plurality of circuits, comprising an access monitoring step of obtaining information on the input and output of data to and from simulation circuits as access information and judging whether or not an order of obtaining the access information is correct based on access order information stored in an access order storage and representing a correct access order of data to be inputted to and outputted from the simulation circuits; and a warning notifying step of notifying a warning to the user if the order of obtaining the access information is judged to be incorrect in the access monitoring step.

Still another aspect of the present invention is directed to a computer-readable recording medium storing a simulation program for simulating the operation of a system circuit including a plurality of circuits, the simulation program causing a computer to function as an access order storage for prestoring access order information representing a correct access order of data to be inputted to and outputted from simulation circuits simulating the circuits; an access monitor for obtaining information on the input and output of the data to and from the simulation circuits as access information and judging whether or not an order of obtaining the access information is correct based on the access order information stored in the access order storage; and a warning notifier for notifying a warning to a user if the order of obtaining the access information is judged to be incorrect by the access monitor.

According to these constructions, the access order information representing the correct access order of the data to be inputted to and outputted from the simulation circuits simulating the circuits of the system circuit are prestored in the access order storage. The information on the input and output of the data to and from the simulation circuits is obtained as the access information, and it is judged whether or not the order of obtaining the access information is correct based on the access order information stored in the access order storage. A warning is notified to the user if the order of obtaining access information is judged to be incorrect.

Thus, incorrect accesses caused by the simultaneous operation of the plurality of circuits can be easily detected, and both the time and developing costs required for analyses to specify the incorrect accesses can be reduced. Since a warning is notified to the user without performing an error processing in the case of an incorrect access, it is possible to increase the simulation speed, to prevent a delay in development and to shorten a development period.

In the above simulation apparatus, it is preferable that the access order storage includes a plurality of access order storages for prestoring the access order information for the respective simulation circuits; the access monitor includes a plurality of access monitors each for obtaining the access information for the corresponding simulation circuit and judging for the corresponding simulation circuit whether or not the order of obtaining the access information agrees with the access order represented by the access order information stored in the corresponding access order storage; and the warning notifier notifies a warning to the user if the order of obtaining the access information is judged to disagree with the prestored access order by any one of the plurality of access monitors.

With this construction, the access order information for each simulation circuit is prestored in the corresponding one of the plurality of access order storages. The access information is obtained for each simulation circuit, and it is judged for each simulation circuit whether or not the order of obtaining the access information agrees with the access order represented by the access order information stored in the corresponding access order storage. A warning is notified to the user if the order of obtaining the access information is judged to disagree with the prestored access order.

Since it is judged for each simulation circuit whether or not the order of obtaining the access information agrees with the access order represented by the access order information stored in the corresponding access order storage, accesses for each simulation circuit can be detected.

The above simulation apparatus preferably further comprises a plurality of access information storages for storing the access information obtained by the plurality of access monitors for each simulation circuit.

With this construction, the access information for each simulation circuit is stored in the corresponding one of the plurality of access information storages, wherefore the stored access information of each simulation circuit can be read out and presented to the user.

In the above simulation apparatus, the warning notifier preferably reads the access information judged to disagree with the prestored access order from the plurality of access information storages and notifies the read access information to the user.

With this construction, the access information judged to disagree with the prestored access order is read from the plurality of access information storages and the read access information is notified to the user, wherefore the user can easily know the cause of occurrence of an incorrect access by confirming the notified access information.

In the above simulation apparatus, the plurality of access monitors preferably obtain the access information from the corresponding simulation circuits, store the obtained pieces of access information in the plurality of access information storages, and judge whether or not the orders of obtaining the pieces of access information stored in the plurality of access information storages agree with the access orders represented by the pieces of access order information stored in the plurality of access order storages after the simulation operations of the simulation circuits end.

With this construction, the pieces of access information are obtained from the respective simulation circuits, and the obtained pieces of access information are stored in the plurality of access information storages. After the simulation operations of the simulation circuits end, it is judged whether or not the orders of obtaining the pieces of access information stored in the plurality of access order storages respectively agree with the access orders represented by the pieces of the access order information stored in the plurality of access order storages.

Since the pieces of access information obtained until the simulation operations of the simulation circuits end are stored and it is judged whether or not the orders of obtaining the pieces of access information agree with the access orders represented by the pieces of access order information after the simulation operations of the simulation circuits end, it is possible to notify a warning to the user upon detecting an incorrect access after the simulation operations of the simulation circuits are performed to the end, instead of notifying a warning to the user upon detecting an incorrect access during the simulation operations of the simulation circuits.

In the above simulation apparatus, it is preferable that the access order storage prestores access order information representing a correct access order of data to be inputted to and outputted from the plurality of simulation circuits in the entire system circuit; the access monitor obtains the access information from the plurality of simulation circuits and judges whether or not the order of obtaining the access information agrees with the access order represented by the access order information stored in the access order storage; and the warning notifier notifies a warning to the user if the order of obtaining the access information is judged to disagree with the prestored access order by the access monitor.

With this construction, the access order information representing the correct access order of data to be inputted to and outputted from the plurality of simulation circuits in the entire system circuit is prestored in the access order storage. The access information is obtained from the plurality of simulation circuits, and it is judged whether or not the order of obtaining the access information agrees with the access order represented by the access order information stored in the access order storage. A warning is notified to the user if the order of obtaining the access information is judged to disagree with the prestored access order.

Since it is judged whether or not the order of obtaining the access information from the plurality of simulation circuits agrees with the access order represented by the access order information stored in the access order storage, it is possible to detect accesses to the entire system circuit constituted by the plurality of simulation circuits, instead of detecting accesses to the respective simulation circuits.

The simulation apparatus preferably further comprises an access information storage for storing the access information obtained by the access monitor.

With this construction, the stored access information of the plurality of simulation circuits can be read out and presented to the user since the access information obtained from the plurality of simulation circuits is stored in the access information storage.

In the above simulation apparatus, the warning notifier preferably reads the access information judged to disagree with the prestored access order from the access information storage and notifies the read access information to the user.

With this construction, the user can easily know the cause of occurrence of an incorrect access by confirming the notified access information since the access information judged to disagree with the prestored access order is read from the access information storage and the read access information is notified to the user.

In the above simulation apparatus, the access monitor preferably obtains the access information from the plurality of simulation circuits, stores the obtained access information in the access information storage, and judges whether or not the order of obtaining the access information stored in the access information storage agrees with the access order represented by the access order information stored in the access order storage after the simulation operations of the plurality of simulation circuits end.

With this construction, the access information is obtained from the plurality of simulation circuits and the obtained access information is stored in the access information storage. After the simulation operations of the plurality of simulation circuits end, it is judged whether or not the order of obtaining the access information in the access information storage agrees with the access order represented by the access order information stored in the access order storage.

Since the access information obtained until the simulation operations of the plurality of simulation circuits end is stored and it is judged whether or not the order of obtaining the access information agrees with the access order represented by the access order information after the simulation operations of the plurality of simulation circuits end, it is possible to notify a warning to the user upon detecting an incorrect access after the simulation operations of the simulation circuits are performed to the end, instead of notifying a warning to the user upon detecting an incorrect access during the simulation operations of the simulation circuits.

The above simulation apparatus preferably further comprises a plurality of simulation circuits. With this construction, the operation of the system circuit can be simulated by comprising the plurality of simulation circuits simulating the plurality of circuits of the system circuit.

In the above simulation apparatus, it is preferable that a simulation circuit storage for prestoring the plurality of simulation circuits, a simulation circuit selection acceptor for accepting the selection of the simulation circuit by the user, and a simulation system circuit generator for extracting the simulation circuit corresponding to the simulation circuit, the selection of which was accepted by the simulation circuit selection acceptor, from the simulation circuit storage and generating a simulation system circuit constituted by the extracted simulation circuit are further provided; and that the access monitor obtains information on the input and output of data to and from the simulation circuit constituting the simulation system circuit generated by the simulation system circuit generator and judges whether or not the order of obtaining the access information agrees with the access order represented by the access order information stored in the access information storage.

With this construction, the plurality of simulation circuits are prestored in the simulation circuit storage. The selection of the simulation circuit by the user is accepted, and the simulation circuit corresponding to the simulation circuit, the selection of which was accepted, is extracted from the simulation circuit storage, and the simulation system circuit constituted by the extracted simulation circuit is generated. Subsequently, the information on the input and output of data to and from the simulation circuit constituting the generated simulation system circuit is obtained as the access information, and it is judged whether or not the order of obtaining the access information agrees with the access order represented by the access order information stored in the access order storage.

Since the plurality of simulation circuits can be selected to generate the system circuit to be simulated, it is possible to simulate the system circuit desired by the user, instead of simulating the predetermined system circuit. Therefore, versatility can be further improved.

In the above simulation apparatus, it is preferable that the access information includes time information representing an elapsed time from a previous access; that the access order information includes time information representing an elapsed time from a previous access for each access; that the access monitor judges whether or not the order of obtaining the access information agrees with the access order represented by the access order information stored in the access order storage and whether or not the time information included in the access information agrees with the time information included in the access order information; and that the warning notifier notifies a warning to the user if the access monitor judges that the order of obtaining the access information disagrees with the prestored access order or judges that the time information included in the access information disagrees with the time information included in the access order information although the order of obtaining the access information agrees with the prestored access order.

With this construction, the access information includes the time information representing the elapsed time from the previous access, and the access order information includes the time information representing the elapsed time from the previous access for each access. It is judged whether or not the order of obtaining the access information agrees with the access order represented by the access order information stored in the access order storage and whether or not the time information included in the access information agrees with the time information included in the access order information. A warning is notified to the user if the order of obtaining the access information is judged to disagree with the prestored access order or if the time information included in the access information is judged to disagree with the time information included in the access order information although the order of obtaining the access information agrees with the prestored access order.

Since it is possible not only to judge whether or not the access information agrees, but also to judge whether or not the elapsed time from the previous access agrees, accesses can be more accurately detected and simulation accuracy can be improved.

In the above simulation apparatus, it is preferable that the access information includes data to be inputted or outputted; that the access order information includes data to be inputted or outputted for each access; that the access monitor judges whether or not the order of obtaining the access information agrees with the access order represented by the access order information stored in the access order storage and whether or not the data included in the access information agrees with the data included in the access order information; and that the warning notifier notifies a warning to the user if the access monitor judges that the order of obtaining the access information disagrees with the prestored access order or judges that the data included in the access information disagrees with the data included in the access order information although the order of obtaining the access information agrees with the prestored access order.

With this construction, the access information includes the data to be inputted or outputted, and the access order information includes the data to be inputted or outputted for each access. It is judged whether or not the order of obtaining the access information agrees with the access order represented by the access order information stored in the access order storage and whether or not the data included in the access information agrees with the data included in the access order information. A warning is notified to the user if the order of obtaining the access information is judged to disagree with the prestored access order or if the data included in the access information is judged to disagree with the data included in the access order information although the order of obtaining the access information agrees with the prestored access order.

Since it is possible not only to judge whether or not the access information agrees, but also to judge whether or not the data included in the access information agrees, accesses can be more accurately detected and simulation accuracy can be improved.

The present invention is capable of easily detecting incorrect accesses caused by the simultaneous operation of a plurality of circuits and reducing the time and developing costs required for analyses to specify the incorrect accesses, and is usefully applicable to a simulation apparatus and a simulation method for simulating the operation of a system circuit including a plurality of circuits, and a computer-readable recording medium storing a simulation program.

This application is based on patent application No. 2006-133300 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A simulation apparatus for simulating the operation of a system circuit including a plurality of circuits, comprising:
an access order storage for prestoring access order information representing a correct access order of data to be inputted to and outputted from simulation circuits simulating the circuits;
an access monitor for obtaining information on the input and output of the data to and from the simulation circuits as access information and judging whether or not an order of obtaining the access information is correct based on the access order information stored in the access order storage; and
a warning notifier for notifying a warning to a user if the order of obtaining the access information is judged to be incorrect by the access monitor.

2. A simulation apparatus according to claim 1, wherein:
the access order storage includes a plurality of access order storages for prestoring the access order information for the respective simulation circuits;
the access monitor includes a plurality of access monitors each for obtaining the access information for the corresponding simulation circuit and judging for the corresponding simulation circuit whether or not the order of obtaining the access information agrees with the access order represented by the access order information stored in the corresponding access order storage; and
the warning notifier notifies a warning to the user if the order of obtaining the access information is judged to disagree with the prestored access order by any one of the plurality of access monitors.

3. A simulation apparatus according to claim 2, further comprising a plurality of access information storages for storing the access information obtained by the plurality of access monitors for each simulation circuit.

4. A simulation apparatus according to claim 3, wherein the warning notifier reads the access information judged to disagree with the prestored access order from the plurality of access information storages and notifies the read access information to the user.

5. A simulation apparatus according to claim 3, wherein:
the plurality of access monitors obtain the access information from the corresponding simulation circuits, store the obtained access information in the plurality of access information storages, and judge whether or not the orders of obtaining the access information stored in the plurality of access information storages agree with the access orders represented by the pieces of access order information stored in the plurality of access order storages after the simulation operations of the simulation circuits end.

6. A simulation apparatus according to claim 1, wherein:
the access order storage prestores access order information representing a correct access order of data to be inputted to and outputted from the plurality of simulation circuits in the entire system circuit;
the access monitor obtains the access information from the plurality of simulation circuits and judges whether or not the order of obtaining the access information agrees with the access order represented by the access order information stored in the access order storage; and
the warning notifier notifies a warning to the user if the order of obtaining the access information is judged to disagree with the prestored access order by the access monitor.

7. A simulation apparatus according to claim 6, further comprising an access information storage for storing the access information obtained by the access monitor.

8. A simulation apparatus according to claim 7, wherein the warning notifier reads the access information judged to disagree with the prestored access order from the access information storage and notifies the read access information to the user.

9. A simulation apparatus according to claim 7, wherein the access monitor obtains the access information from the plurality of simulation circuits, stores the obtained access information in the access information storage, and judges whether or not the order of obtaining the access information stored in the access information storage agrees with the access order represented by the access order information stored in the access order storage after the simulation operations of the plurality of simulation circuits end.

10. A simulation apparatus according to claim 1, further comprising a plurality of simulation circuits.

11. A simulation apparatus according to claim 1, further comprising:
a simulation circuit storage for prestoring the plurality of simulation circuits,
a simulation circuit selection acceptor for accepting the selection of the simulation circuit by the user, and
a simulation system circuit generator for extracting the simulation circuit corresponding to the simulation circuit, the selection of which was accepted by the simulation circuit selection acceptor, from the simulation circuit storage and generating a simulation system circuit constituted by the extracted simulation circuit,
wherein the access monitor obtains information on the input and output of data to and from the simulation circuit constituting the simulation system circuit generated by the simulation system circuit generator and judges whether or not the order of obtaining the access information agrees with the access order represented by the access order information stored in the access information storage.

12. A simulation apparatus according to claim 1, wherein:
the access information includes time information representing an elapsed time from a previous access;
the access order information includes time information representing an elapsed time from a previous access for each access;
the access monitor judges whether or not the order of obtaining the access information agrees with the access order represented by the access order information stored in the access order storage and whether or not the time information included in the access information agrees with the time information included in the access order information; and
the warning notifier notifies a warning to the user if the access monitor judges that the order of obtaining the access information disagrees with the prestored access order or judges that the time information included in the access information disagrees with the time information included in the access order information although the order of obtaining the access information agrees with the prestored access order.

13. A simulation apparatus according to claim 1, wherein:
the access information includes data to be inputted or outputted;
the access order information includes data to be inputted or outputted for each access;
the access monitor judges whether or not the order of obtaining the access information agrees with the access order represented by the access order information stored in the access order storage and whether or not the data included in the access information agrees with the data included in the access order information; and
the warning notifier notifies a warning to the user if the access monitor judges that the order of obtaining the access information disagrees with the prestored access order or judges that the data included in the access information disagrees with the data included in the access order information although the order of obtaining the access information agrees with the prestored access order.

14. A simulation method for simulating the operation of a system circuit including a plurality of circuits, comprising:
an access monitoring step of obtaining information on the input and output of data to and from simulation circuits as access information and judging whether or not an order of obtaining the access information is correct based on access order information stored in an access order storage and representing a correct access order of data to be inputted to and outputted from the simulation circuits; and
a warning notifying step of notifying a warning to the user if the order of obtaining the access information is judged to be incorrect in the access monitoring step.

15. A computer-readable recording medium storing a simulation program for simulating the operation of a system circuit including a plurality of circuits, the simulation program causing a computer to function as:
an access order storage for prestoring access order information representing a correct access order of data to be inputted to and outputted from simulation circuits simulating the circuits;
an access monitor for obtaining information on the input and output of the data to and from the simulation circuits as access information and judging whether or not an order of obtaining the access information is correct based on the access order information stored in the access order storage; and
a warning notifier for notifying a warning to a user if the order of obtaining the access information is judged to be incorrect by the access monitor.
